(19) United States
(12) Patent Application Publication
(10) Pub. No.: US 2005/0289216 A1
(43) Pub. Date: Dec. 29, 2005

(54) Providing personalized services for mobile users

(76) Inventors: Andreas Myka, Helsinki (FI); Jukka Yrjanainen, Ylojarvi (FI)

Correspondence Address: PERMAN & GREEN, 425 POST ROAD, FAIRFIELD, CT, 06824, US

(21) Appl. No.: 10/502,280

(22) PCT Filed: Mar. 28, 2002
(86) PCT No.: PCT/FI02/00276

§ 371 Date: May 11, 2005

(51) Int. Cl. G06F 15/16

(52) U.S. Cl. 709/201

(57) ABSTRACT

The invention relates to providing personalized services for mobile users. Personalized services can be provided to users, for example, by delivering them using mobile communications means or other delivery methods, such as printed magazines. Personal content is acquired by and stored on a mobile terminal. At least one remote repository is assigned for the use of each such terminal. Selected content can then be transferred from the mobile terminal to a remote data repository through a telecommunications system. Thereby, a transfer is preferably initiated when at least one predetermined criterion is fulfilled. The transferred personal content is subsequently stored in the remote data repository. Data is extracted from the personal content, and the personal content is associated with the extracted data. The latter step can be executed on the terminal and/or on the remote server.

### FIELD OF THE INVENTION

The invention relates to providing personalized services for mobile users. Personalized services can be provided to users, for example, by delivering them using mobile communications means or other delivery methods, such as printed magazines.

### BACKGROUND OF THE INVENTION

The strong growth in the number of Internet users and the number of services provided through the Internet has been one of the most remarkable phenomena in communications in recent years. Another current trend is the strongly increasing use of various mobile terminals which make use of wireless communication, such as laptops, PDA (Personal Digital Assistant) equipment, and intelligent telephones.

These two rapidly evolving network technologies, wireless communication and the Internet, are gradually converging to make available to mobile users the packet-switched data services used on the Internet. So far this converging development has been progressing rather slowly, since most of the technology developed for the Internet has been designed for desktop computers and medium or high bandwidth data connections. It has, therefore, been difficult to introduce IP-based (IP=Internet Protocol) packet services to the mobile environment, which in comparison to fixed networks is characterized by less bandwidth and poorer connection stability, with terminals having many fundamental limitations, such as smaller displays, less memory, and less powerful CPUs than fixed terminals. However, the development of IP-based packet services for the mobile environment will occur at an increasing rate in the foreseeable future. This is partly due to the demand created by the market, to the evolvement of new technologies designed to meet the various requirements of mobile networks, such as sufficient quality of service and data security, and partly due to the fact that some of the limitations of mobile terminals (memory, processing power) are becoming less significant. The increasing market demand is based on the rapid increase in the popularity of the Internet: Internet users are often also mobile subscribers and thus may also want to use at their mobile terminals the services familiar to them from the Internet environment. This commercial demand in turn enables investments necessary for the development of mobile services. Examples of said new technologies are GPRS (General Packet Radio Service) and WAP (Wireless Application Protocol). GPRS aims at providing high-quality services for GSM subscribers by efficiently utilizing the GSM infrastructure and protocols. WAP, in turn, defines a set of standard components enabling communication between mobile terminals and servers to provide services available in the network. WAP utilizes proxies that connect the wireless domain with the WWW (World Wide Web) domain.

The described development will in the near future turn the mobile terminals into versatile multimedia tools. In addition to the features that current mobile terminals include, these future terminals will have a variety of sensors for multimedia data, for example, such as a camera and a location sensor. Besides the technical feasibility of constructing such devices, it is important that the users get a clear benefit from using such terminals and that the telecommunications system to which the terminals belong does not pose restrictions on the efficient use of the devices.

In comparison to already existing multimedia tools, such as digital cameras, the recent development of mobile terminals can offer a variety of new multimedia-related services, as the technological solutions used by the mobile terminals and the mobile network infrastructure enable various possibilities not seen before. On the other hand, the interconnected networks, such as the Internet, act as enabling factors as well. The possibilities thus created have so far mostly been unexplored, leaving space for innovative practices and new service models within the communications industry.

One example of the immense possibilities mentioned above is sometimes referred to with the general term “metadata”. Metadata itself is data about data, defining new relations inside a batch of data and building new ontological layers. The existing solutions for generating and using metadata by no means effectively utilize the many possibilities offered via mobile terminals. Some prior art examples are described in more detail in U.S. Pat. No. 6,282,362 and European patent application 1 004 967. Typically, images play the role of multimedia information, and for images, metadata may be the location where a picture was taken or the subject of an image.

However, none of the referred solutions is capable of offering a total solution for a mobile terminal user with respect to flexibility in content creation and usage. Because all possible solutions are developed from a narrow point of view with the aim of resolving a single problem each time, to a large extent the demands raised by the users as well as the possibilities offered by the versatility of the systems used have not yet been explored.

The objective of the invention is to introduce a novel concept that makes use of the described capabilities in such a way that the users can be provided with a wide variety of personalized value-added services or features. The dependent claims describe the preferred embodiments of the invention.

### SUMMARY OF THE INVENTION

In accordance with the present invention, personal content is acquired by and stored on a mobile terminal. At least one remote repository is assigned for the use of each such terminal. Selected content can then be transferred from the mobile terminal to a remote data repository through a telecommunications system. Thereby, a transfer is preferably initiated when at least one predetermined criterion is fulfilled. The transferred personal content is subsequently stored in the remote data repository. Data is extracted from said personal content and the personal content is associated with said extracted data—the latter step can be executed on the terminal, on the remote server, or on the remote repository.

In accordance with one aspect of the present invention, data to be used for generating a personal service is selected from external data storage, the selection being made at least partially on the basis of said extracted data. The selected data is received and then associated with the personal content stored in the data repository. The data received is then further utilized when providing the service.

In accordance with another aspect of the present invention, at least one stored object and/or item of extracted data is retrieved from the remote data repository. An action is then performed utilizing the retrieved object and/or said extracted data, and as a result of the action information is generated.

In accordance with a further aspect of the present invention, the extracted information is stored in said remote data repository.

In accordance with a still further aspect of the present invention, charging information is generated on the basis of the action performed.

In accordance with a still further aspect of the present invention, a service is subscribed to by sending a request to a predetermined server. The request is then processed and in response to said processing, the access is allowed to an object and/or stored information in the remote data repository.

The user may subscribe to services by sending a request to a predetermined server. The request may contain an identifier which identifies, for example, a service, and/or an object and/or item of extracted information on which the action is to be performed when providing the service. It is also possible that the request contains a set of such identifiers. The request may be processed further in order to enable the production of the service in parts, or in other words, to enable partial use of the service.

As an example, the service to be provided to the user may include a personal magazine in paper or digital format. In this case the data transferred from the mobile terminal comprises at least one item of the following data: i) calendar information, ii) image or video information, or iii) location information for the user, as well as selected data retrieved from an external data storage. Preferably, said data includes information to be laid out in the personal magazine. Further, in the selection step date and location information extracted from said personal content can be used in selecting objects or extracted data from a time interval to be laid out in the personal magazine. The extracting step may further include at least performing i) optical character/text recognition or ii) pattern recognition.

### BRIEF DESCRIPTION OF THE DRAWINGS

The invention is described more closely with reference to FIG. 2-12 of the accompanying drawings, in which

FIG. 1 illustrates a mobile network wherein prior art services are provided to the users,

FIG. 2 is a schematic diagram of a system which can be used to provide personalized services according to the invention, the diagram describing network elements favourable when implementing some embodiments of the invention,

FIG. 3A shows sample content of a software block of a user terminal 100 which can perform some tasks described in a preferred embodiment,

FIG. 3B illustrates the hardware block of a user terminal 100,

FIG. 3C illustrates the contents of the storage means of a user terminal 100,

FIG. 4A illustrates the functional blocks of the software in the server MD DB 240,

FIG. 4B represents the contents of an exemplary remote data repository 242,

FIG. 5 is an example of the functional blocks of the application server 250,

FIG. 6 is a diagram showing an exemplary utilization of a personalized service,

FIG. 7 is a block diagram of exemplary processing of a request for a personalized service,

FIG. 8 is an exemplary signaling diagram showing the messaging between the different system parts when generating a personalized service,

FIG. 9A/B is a signaling diagram showing how the uploading of the content used for the personalized service is handled,

FIG. 10 is a diagram showing how the present invention can be applied when the service to be provided to the user is a personalized magazine,

FIG. 11 is a diagram showing how the personalized magazine can be further personalized using personal content taking into account some data confidentiality issues, and

FIG. 12 is a diagram showing an example of the principles of adding services of third parties, putting an emphasis on user data confidentiality issues.

### DETAILED DESCRIPTION OF THE INVENTION

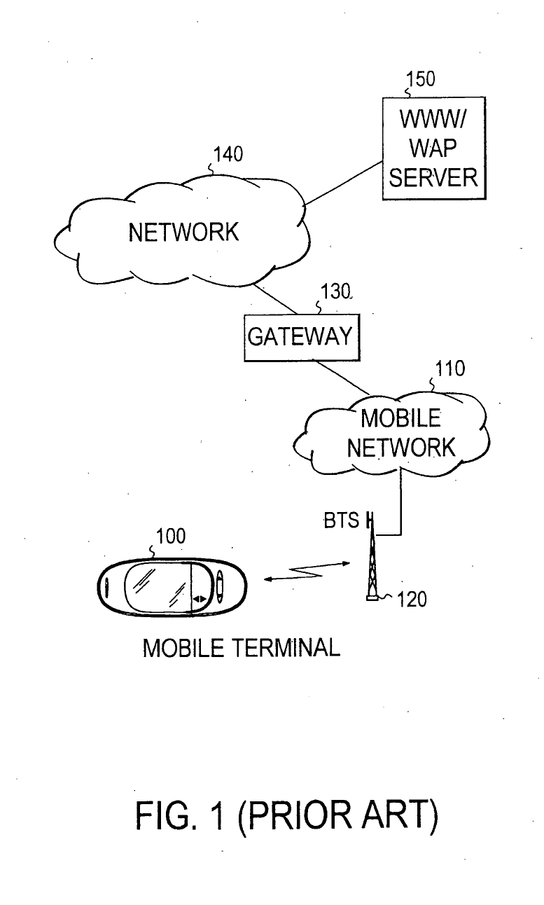

FIG. 1 shows a schematic diagram of a prior art system for providing services for mobile users. A mobile network 110 is connected via a gateway element 130 to a communications network 140, such as the Internet. These kinds of arrangements are widely used to provide services to user terminals, of which one mobile terminal 100 is illustrated in the figure. Mainly, the terminals are connected with the mobile network via base transceiver stations (BTS), of which only one BTS 120 is illustrated in FIG. 1. The BTS in plurality form a radio access network for the network 110.

Many services provided to users are produced in different servers, of which only one WWW/WAP server 150 is illustrated in FIG. 1. The servers 150 are mostly connected directly to the Internet and provide many different services, such as following the stock exchange rates applying criteria supplied by the user subscribing to the service in question. When the server detects that some criterion is fulfilled, it notifies the user by sending a message. Further, services such as directory services or anonymous chat services may be implemented using a server system similar to the example above.

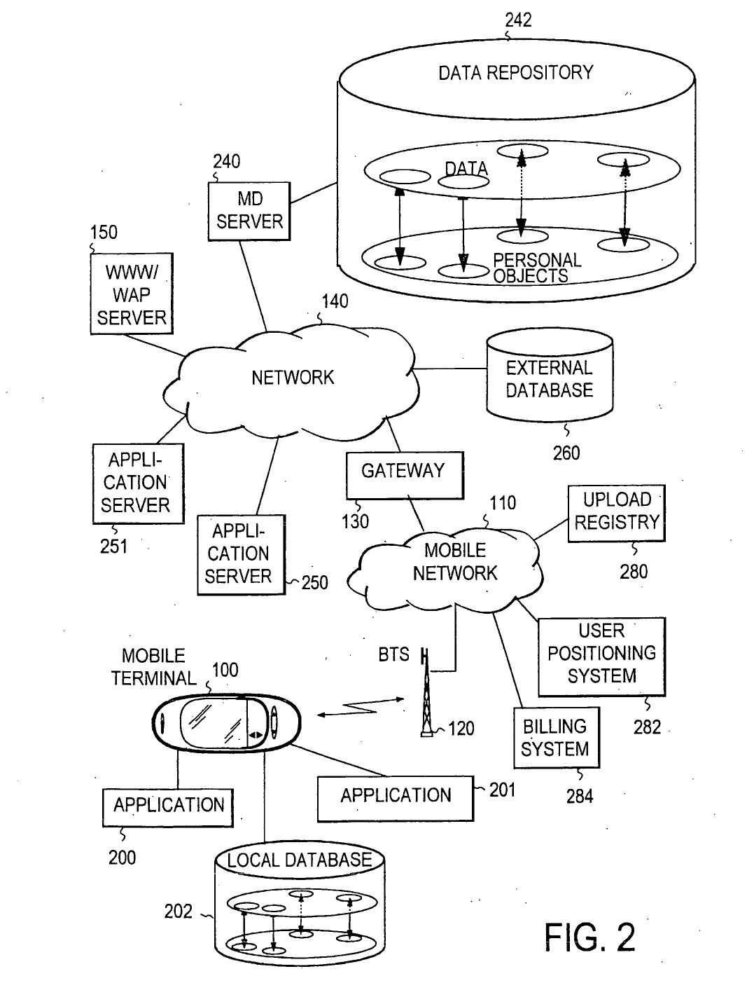

FIG. 2 shows some aspects necessary,for designing a network architecture in view of the recent development trends. Because the mobile terminals have been evolving towards versatile multimedia tools, they are equipped with some preinstalled applications. Examples of typical applications are a camera user interface and personal information management (PIM) applications, such as calendar and contact management application and data storage logic, which can also be implemented in a software application to facilitate the possibilities offered by the terminal hardware. The application data forming personal content is stored in a local database 202, which can in practice be a memory chip or a local disk drive. These are commonly understood to be hardware parts, but normally the database comprises both hardware and software as discussed below. The idea is to implement the system using different functional parts providing the user with a reliable means for storing information. According to the invention, the mobile terminal 100 is provided with a plurality of applications, of which two examples 200 and 201 are presented in FIG. 2. The applications have means to access the content and, if necessary, to perform simple analytic tasks or to transfer the content to a remote data repository 242. Further, the system comprises a Media Diary (MD) server 240. The MD server is provided with several functionalities, not only controlling access to the remote data repository, i.e. the MD database (DB), but performs other tasks quite like a user would carry out using a traditional diary and notebook. Basically, in the terminology used further in this description, the term Media Diary defines the concept of collecting personal content acquired by the user, further refining it, and then using of it when generating services. In other words, the Media Diary is a multimedia equivalent to a traditional diary in which the user may collect photos, memos, and other practical stuff, which when combined with the possibilities of the digital world are used in producing services.

Further, the system comprises a plurality of different application servers 250 and 251. It is to be noted that the servers need not be separate elements, but that in some cases the applications may be stored in the MD server as well. The same applies to the remote data repository 242, which can be included in the MD server 240. According to one aspect of the present invention, the different elements together with their functionalities comprise an MD system which includes a server, a data repository, and means to execute some applications stored somewhere in the network. The purpose of the MD system is to provide the user with a reliable data storage on the one hand, and on the other hand, with a possibility to easily gain the advantage of personalized services. The remote data repository may thus contain objects that form the personal content, metadata extracted from said objects and retrieved from other sources, and other data retrieved from other sources.

The system has access, if necessary, to one or several external databases 260. This can easily be implemented using the Internet or some other communications network.

The user data is transferred from the local database 202 to the data repository 242. For the uploading task an upload registry 280 may be involved. Typically, modern mobile networks also include other practical means, such as a user positioning system 282 and a billing system 284. Some components, such as a positioning system 282 or an external data-base 260, are already known from prior art, but they are presented here with reference to FIG. 2 because some aspects of the present invention enhance the use of these systems in the manner described below.

The conceptual difference between external data storage 260 and a remote data repository 242, as used here, is not a physical one, but a matter of logic. The remote data repository is dedicated for storing personal content of mobile users, such as personal content objects and data extracted from them, and for storing data which forms some personalized services. The external data storage is basically used for data retrieval, the data not necessarily being personal but fetched from other sources, such as the Internet or a newspaper. The data retrieved from the external data storage may be further analyzed or handled, and the results may be stored in the remote data repository. As a part of the conceptual realization of the MD system, the remote data repository provides a remote safe box for the personal data of the user.

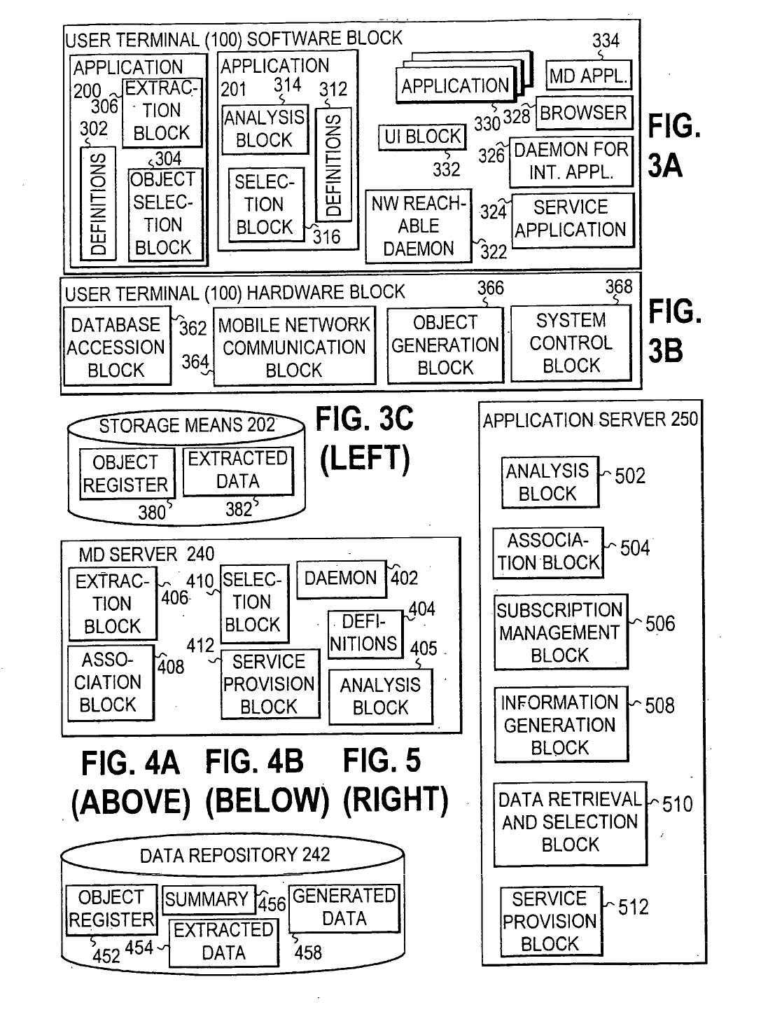

FIG. 3A is a schematic diagram of a software block of the user terminal 100. Application 200, which can be used to extract data from an object, includes definitions 302 which define some settings, such as which kind of objects the application is capable of working on, then possibly some adjustable parameters, such as the resolution settings for digital images, and so on.

Application 201 comprises in addition to definitions 312 also analysis block 314 and then selection block 316. Application 201 may be used, for example, for inquiring about the terminal data storage status and then selecting files to be deleted if necessary.

The mobile terminal may comprise a plurality of other applications 330 as well, in addition or instead of applications 200 and 201. The mobile terminal usually also contains some form of user interface UI block 332. According to one aspect of the present invention, the user terminal may have a Media Diary MD application as well. Typically, some mobile terminals also comprise a browser 328. The MD application is intended to convert the user terminal into a versatile multimedia tool capable of providing special services related to the personal content acquired by the user. Such services are various, but in view of the enhanced data storage functionality, basically the services relate to the associating of metadata related to personal content (or data which has been extracted from said personal content) to the personal content itself, extracting information from said content, transfering of the content to and from the remote data repository, accessing said stored content, performing some actions like deleting obsolete or outdated information from the user terminal, and so forth. In principle it is one objective of the MD application to provide the user with a user interface and means to setup all the various definitions and with operating models related to these functionalities, which thus act as a sort of front end. Even if the tasks described above are performed by dedicated program applications, some of them residing in the mobile terminal and some of them in a networked computer or server, and adapted to be independent in the sense that the special MD application is not necessary, it is under current development work in order to offer the user a single point of control and use.

Further, the user terminal has two different daemons available. The network reachable daemon 322 takes care of connections initiated from the mobile network 110 or some other communications network 140, such as the Internet. The daemon 326 for internal applications acts as a middleman between the hardware and software. It may also monitor the actions of other applications and perform some predetermined tasks when deemed necessary.

FIG. 3B is a schematic block diagram of the hardware block of the user terminal. In this context the hardware is considered functionally separate one from the storage means 202, but it is to be understood that it is also possible to implement both functionalities together in a hardware block, basically because the physical realization of the storage means always requires some sort of hardware. Usually the functionalities in the hardware are performed by software as well, but because more efficient processing is desired, the software is coded in low-level programming language and stored in a read-only memory. However, this is not to be considered as a limitation, but as one possibility to enable efficient implementation of the invention. The hardware block has a database accession block 362 with means to perform operations on the storage means 202. Then the hardware block has means in the mobile network communication block 364 to be in communication with the mobile network 110 and its base transceiver stations 120. Further, the object generation block 366 can assist in generating personal content objects, be they digital images, calendar entries, speech, or text messages generated by some application or via some part of the hardware. The system control block 368 supervises the system and keeps the different functional blocks in the hardware running.

FIG. 3C is a simplified block diagram of the local storage means 202 of the mobile terminal. First, the storage means has an object register 380 which is intended for storing personal content. Secondly, there is an also extracted data block 382 for extracted data. Typically, such data extraction may be performed in the extraction block 306 of some application, for example.

FIG. 4A shows a simplified structure of the MD server 240. The server has a daemon 402 to activate the correct service provision block 412. For this, both the daemon 402 and the service provision block 412 have definitions 404 which contain, for example, information on requirements posed by the services and different options for service requests. In order to complement this task, the MD server may also have data extraction tools in an extraction block 406. Because the user data which forms at least a part of the personal content is stored in the data repository 242, the extracted information has to be associated to the corresponding personal content or content object. Therefore, the system also has association tools in the corresponding association block 408. Due to the possibly large number of personal content items, the system may further comprise selection tools in a selection block 410 which takes care that the right personal content, either in the form of an object or extracted data, is appropriately selected for the provision of the personalized service.

FIG. 4B is a schematic block diagram of the functional blocks of an exemplary remote data repository 242. First of all, the repository contains personal content in the form of objects in the object register 452. The repository may also contain a summary 456 of the content stored in the register. To this content may belong data extracted 454 from the objects and also data generated 458 by some services. It is to be noted that the services may be provided in the service provision block 412 of the MD server, in a separate application server 250 and/or 251. The production or provision of services may also be performed in steps in such a way that some parts of the service are generated in one server and some other parts in the other. It is clear that the designing of the services gets a bit more complicated when the number of involved servers increases. Finally, the service may be combined from several parts to form the complete personalized service, and the combination can be performed either at some server in the system or at the user terminal. In the latter case the combination of the service from elements may be virtual, so that the user cannot know how the different elements of the service are actually produced.

FIG. 5 is a block diagram of an exemplary application server 250. First, the application server receives a request. The request is then analyzed in the analysis block 502. The analyzed request is then associated with some service or some mode of the service, which may be identified on the basis of the parameters or options in the service request, for example. For this each block in FIG. 5 may have its own definitions, if necessary, and in practice (there is also one common definitions file for the application server as well. The association is performed in the corresponding association block 504.

In some cases, especially for different commercial services, there is a subscription management block 506 in the application server as well. If a service is provided for free, such as for advertising purposes, subscription management may not be necessary. It can, of course, still be used for collecting statistics etc.

The information generation block 508 analyzes the personal content and generates information on the personal content. It may also perform the functions of combining information from different sources, and even combining different parts of the personal content. The personal content is preferably delivered to the service with the request, as this minimizes the amount of necessary signaling. However, because this is not always the case, the application server also has a data retrieval and selection block 510. This is useful also for retrieving information from other sources, such as web search engines, external web databases, or other connected information systems. Finally, the service provision block 512 has means for providing the service, or at the sub-service level (that is, part of the service level) some content to be used for the building of the complete service. The service provision is performed by combining information both generated and retrieved. This information may further be altered or analyzed to better meet the objectives of providing personalized services.

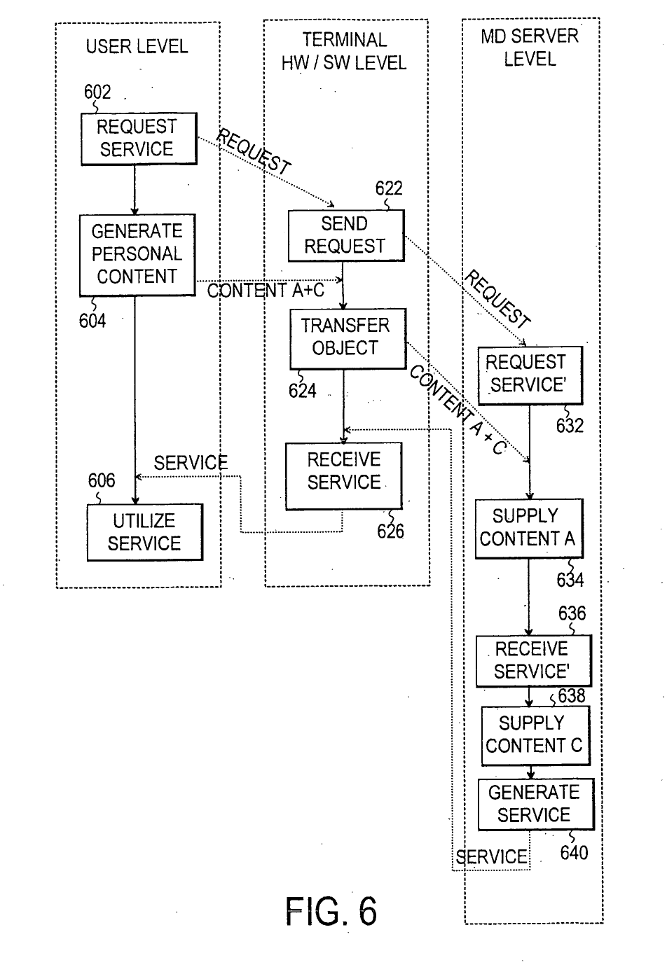

FIG. 6 illustrates in diagram format how the user acts when requesting request-based services. These are services of a separate class, which are thus distinguished from continuously subscribed services. The same principle applies to continuously subscribed services, in the sense that the user may decide what kind of content to include for a specific realization of a service by indicating his/her own preferences, which preferably are stored in the corresponding definitions of the service.

The user requests a service in step 602. The request is sent (step 622) by the terminal software and hardware to the MD server. The request arrives at the MD server, which may start processing the request. When the service is generated at a separate server, the MD server may send a further request (step 632) to a further server which provides SERVICE′ to the MD server. Other possibilities are that the MD server changes definitions of the daemon to a monitoring state which waits until some personal content arrives at the MD server, or that the MD server only notifies the separate server of users interested. In this case the physical realization of the service may be generated later at a given point, e.g. an article about a football match may be written if there were enough requests for such an article.

In step 604 the user generates an object with personal content, such as a digital image, a calendar entry, or a geographical location. Further on, the first part of the content is labeled CONTENT A and the second part of the content is labeled CONTENT C in FIG. 6. It is to be noted that it is not necessary that there are these two separate content elements but this notation is used only to illustrate an exemplary case for use of the present invention per se.

The content is transferred further via the terminal (step 624) to the MD server. The MD server supplies (step 634) the CONTENT A to the server generating the SERVICE′. After the server has completed its tasks, the MD server receives (step 636) the SERVICE′ and further combines it with CONTENT C. This is marked as step 638 in FIG. 6 (i.e. supply CONTENT C) and may further include supplying CONTENT C to service provision block 412. Finally, the complete service is generated (step 640) and then delivered to the user device which receives it (step 626). Here the user may utilize the service in question (step 606). It is not necessary to send the service to the user terminal, especially in cases where the service is in another format possibly incompatible with the terminal, such as a newspaper or magazine subscription. Hence, the step 626 may be omitted without any difference in the inventive concept. The terminology used refers to cases where the service is a tangible service, such as a printed magazine, newspaper, or even some goods delivered to the user, in contrast to an intangible service provided to the user, such as digital publications or a haircut.

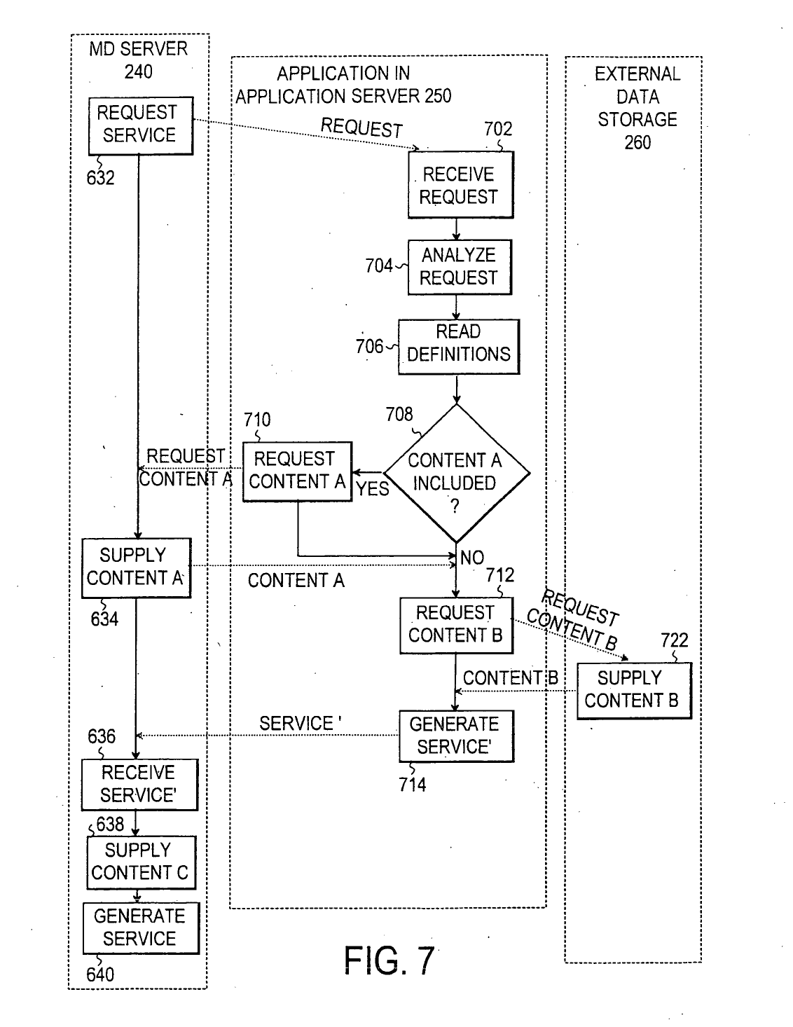

FIG. 7 illustrates how the flow of information may be realized between the MD server 240, the application server 250, and the external data-base 260. In step 632 the MD server requests service from the application server by sending a request. The application server may be a separate server, the application may be within the MD server, or if the remote data repository is physically the same element as the MD server, the application may reside even within the repository.

The application receives a request K5 in step 702. The request may be analyzed (step 704) to check in which format the request is, i.e. what are the parameters and options. The request may include some personal content to be used for the service. If the options or parameters are forwarded to the analysis block, the analysis may be performed in a different application as well.

If there are any definitions related to the service set-up, they are read in step 706 when the analysis step is required prior to reading and selecting the parameters. Some definitions may also be read earlier in order to decide whether the request is to be analyzed or not.

In step 708 it is checked whether CONTENT A is included in the request. In a positive case, or if CONTENT A is not necessary for fulfilling the request, the processing may continue in step 712. In the opposite case the content may be requested from the MD server (step 710), or in some cases from the user terminal. The content is preferably stored in a remote data repository, but if it is not located there, it may be stored in the data storage of the terminal. The MD server supplies (step 634) the application with CONTENT A. It is also possible that CONTENT A is supplied to the corresponding application directly from the user terminal, passing via some necessary network elements, of course.

The next thing to do in step 712 is to request CONTENT B. This may be performed in different ways. For example, if the CONTENT B is stored in the application server, it may be read into the computer's main memory. The CONTENT B to be requested may be selected according to the request which has been analyzed in step 704, or according to the definitions, such as the user profile. The request may be communicated to an external data storage element 260, which supplies CONTENT B in step 722. CONTENT B may be any content useful for the generation of SERVICE′. It may be stored in any remote data repository, such as a server connected to the Internet, or it may be manually inserted in the application server 250.

The SERVICE′ is generated in step 714, and then further communicated to the MD DB service. The MD DB service receives (step 636) the SERVICE′ and may further personalize it by supplying CONTENT C to it. After this step the SERVICE is ready to be provided to the user. This kind of two-layer structure in producing personalized services is one aspect of the present invention. The layers may comprise information or means for processing information delivered by third parties (CONTENT B). According to one aspect of the invention, the processing may also be performed on information which may include some confidential data, such as CONTENT C. However, it is to be noted that the invention may be implemented even with a one-layer mechanism for providing a personalized service.

There may be different kinds of associations between the layers. In practice this may mean that the relationship between different contents; such as CONTENT B and CONTENT C is described. The relationship may be described with associators generally used for linking two objects together, for example. The associators are usually implemented using association means, such as a computer code having means which enable detecting an existing relationship between a group consisting of at least two objects, and/or creating new relationships between objects.

The associators may be further used in such a way that the service providing means may be responsive to some of the associators in such a way that the service providing means can be arranged to detect and analyze whether associators are needed. In this way the service providing means can select the right kind of content from the user personal data collection, i.e. the remote repository, for use when providing the service. Because the service providing means may comprise a plurality of different service provision blocks, it is to be understood that in this way a combination of the blocks, or even a single block may form the service provision software.

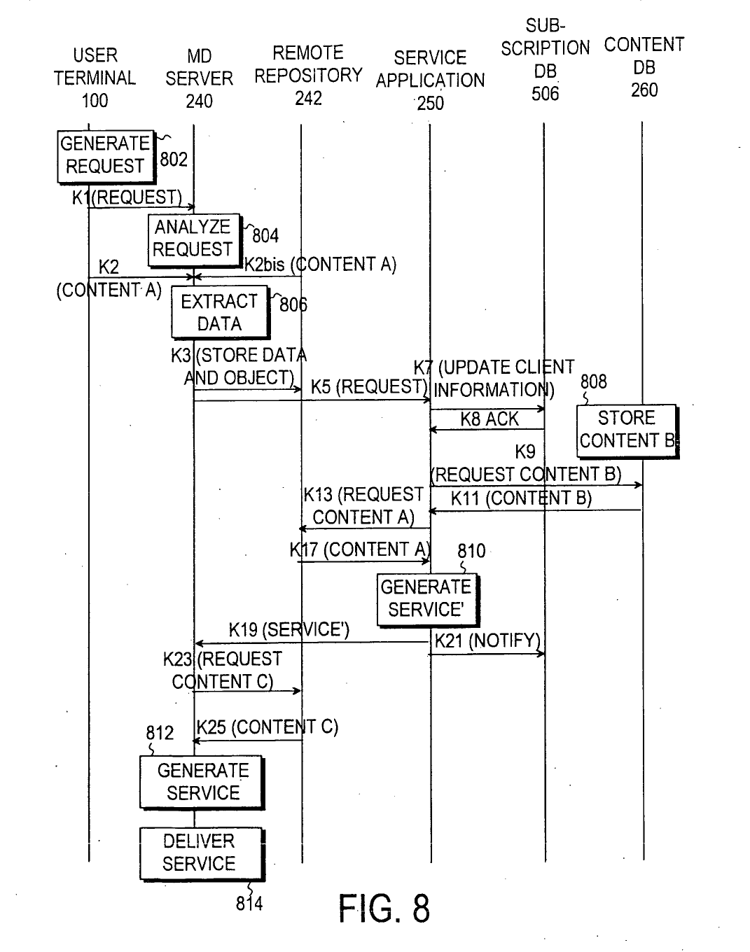

FIG. 8 is a signaling diagram showing exemplary messaging between different system elements, with some details neglected in FIG. 6 and 7. The messages are identified with arrows between the system elements, and some processing tasks are presented with boxes including a broad description of the task involved.

First, a request K1 is generated (step 802) in the user terminal 100. This may be performed by the user or the hardware. The generation of request K1 can be automated by simply pressing a button on the mobile terminal keypad, or after fulfillment of a predetermined criterion such as a calendar entry comparable to a clock value, or when a received position triggers the step 802. It may also be generated manually by the user typing a simple text message like a note, which is either sent to the network by the user or detected by an application in the mobile terminal triggering the exchange of the messaging.

The MD server 240 receives the request K1 and analyzes it in step 804. The message K1 may include some content suitable as CONTENT A, or CONTENT A may be supplied in the separate message K2. The next step 806 is data extraction. Also data provided earlier to the remote repository can be extracted. This can be provided in the analysis step by a normal request-response pair, or if the remote data repository has means to automatically deliver suitable data for services subscribed to by the user, merely by pushing them from the remote repository to the MD server as a message K2bis. The analysis may be performed again in a different processor, which may be located in a different server as well. Different analysis methods can be triggered here, such as pattern recognition, image analysis, parameter extraction, the mapping of different parameters such as positioning results, and so on. As one application, text content from a calendar entry may be extracted; the text extracted may be further analyzed and on the basis of the analysis results, the text and images relevant to the calendar entry may be selected. Partially, this is to be performed at the service application level but nothing prevents doing it at the MD server either.

The MD server 240 preferentially stores extracted data in the remote repository 242 by sending it together with the object forming the personal content in message K3. The extracted data is associated with the personal content so that by referring to a specific personal content object also relevant extracted data may also be found. Further, the association may utilize some ontological principles, where the extracted data are given some meaning and then the data is used, for example, selected as an input of some service, depending on the meaning. Of course, the same applies also to data retrieved, or to data generated on the basis of the further analysis steps, which has been referred to as different than plain extraction of data.

SERVICE′ is requested by the MD server by sending a request K5 to the service application 250. When the service is subscription-based, the user may be requested to confirm the subscription, after which the client information is stored in the subscription database 506 by sending a message K7. Otherwise, if deemed necessary, the client information may be updated to include the request received. The message K7 may include a client identifier, and if the same service system supplies different services, the message preferentially includes a service identifier as well. The billing may be performed via the MD server system, but the request may contain a credit card number as well, providing the service application has access means for sending billing information to a credit card billing database of a credit card company. Similar approaches are applicable as well, because the charging, despite its relative importance as a motivator in creating and providing the service, does not play a significant role in the production of the service, which is more a technical matter. The return message K8, if any, can be an acknowledgement indicating that the user is privileged for the service, i.e. that the billing aspects are in order and so forth. Alternatively, a negative acknowledgement showing that the service should not be provided to the user may be generated.

CONTENT B is stored in external data storage 260 acting as a content database. It is to be noted that the external data storage as described here may be a web search engine which stores a multitude of different information, or data storage for articles in an electrical form, etc. Hence, some content (i.e. CONTENT B) is preferably stored even before it is requested. CONTENT B may be generated, for example, by retrieving information from the Internet, by an editor writing articles, or by merchandising articles from a news company and then storing them in the storage means. CONTENT B may be requested (message K9) from the content database if it is not supplied automatically, for example, based on a date criteria. All relevant data can be delivered automatically once a week or once a month, for example. The delivery of CONTENT B is preferably performed by sending it (message K11) to the service application.

The service application may further request (message K13) CONTENT A from the repository, which then delivers it (message K17) if CONTENT A was not included in the request and is necessary for generating the SERVICE′. After this step the SERVICE′ may be generated. The generated service is further delivered (message K19) to the MD server, and notification (message K21) can be sent to the subscription database to indicate that the service has been generated for the user.

The MD server uses the SERVICE′ together with CONTENT C to generate the SERVICE. In order to do this, CONTENT C must be requested (message K23) from the remote data repository 242, which delivers CONTENT C in a message K25. In step 812 the SERVICE is generated and then further delivered (step 814) to the user. It is to be noted that the service does not necessarily have to be delivered by the MD server 240, but basically any service application, such as 250 in FIG. 8, may perform this task. In some embodiments of the present invention, even the delivery mechanism can vary, for example, if the service is a personal magazine that is printed on paper and then delivered to the user.

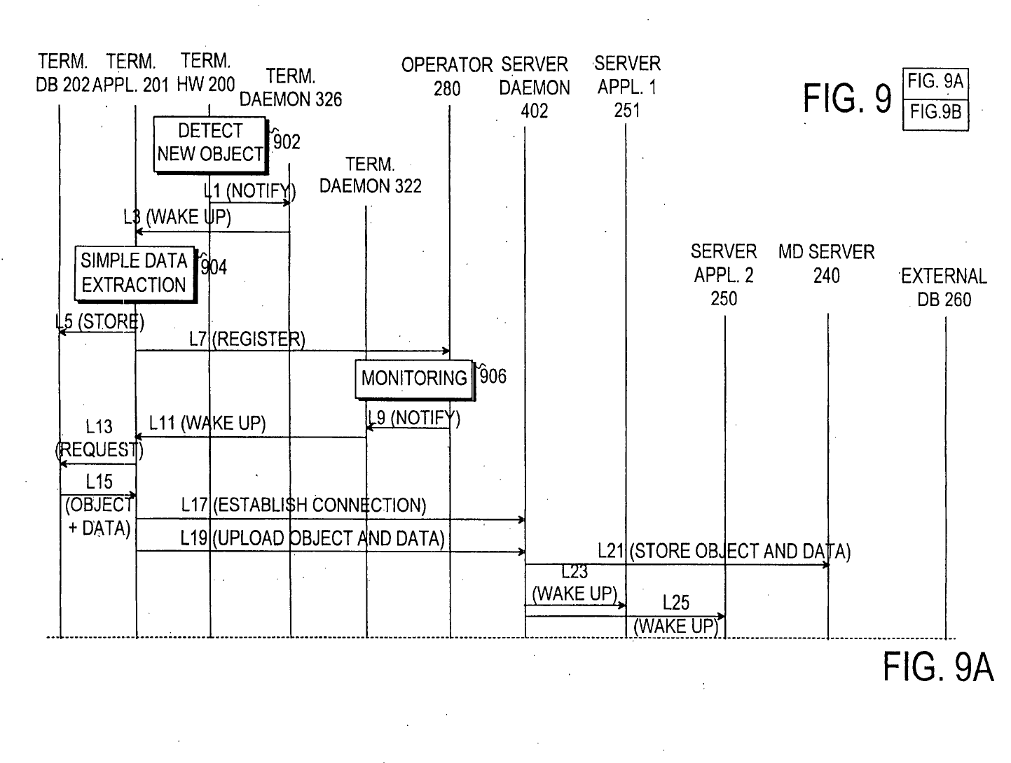

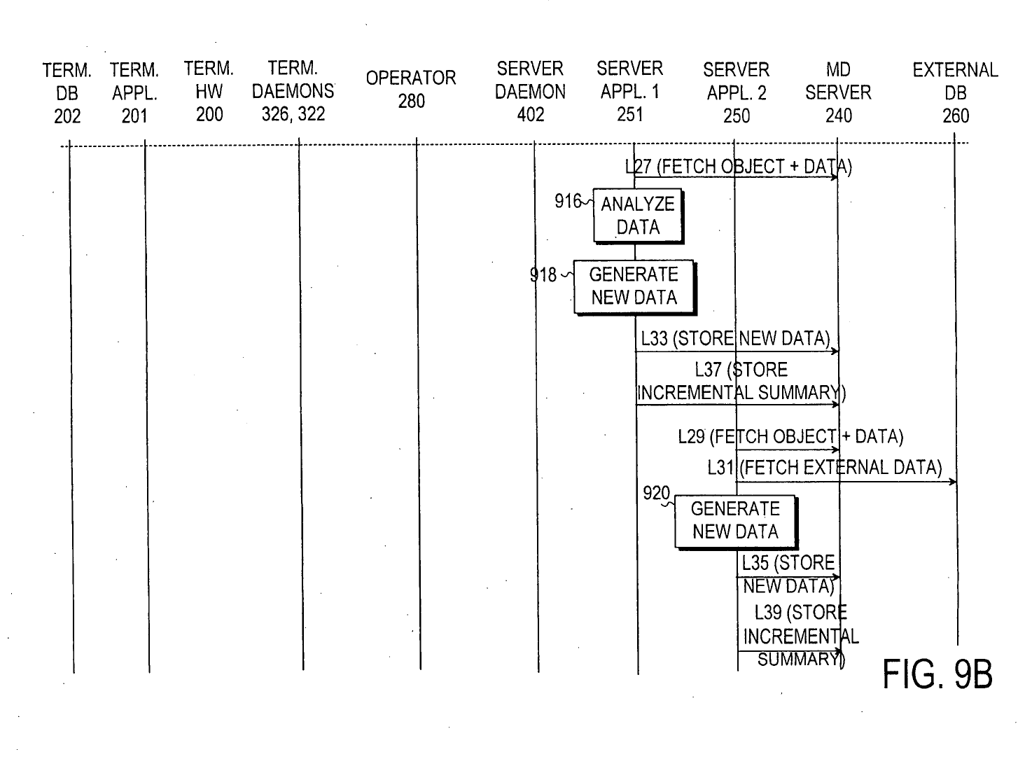

FIG. 9 is an example of the delivery of CONTENT A and C to the remote data repository. The implementation of the personal content delivery mechanism is not important in regard to the nature of the present invention, because in principle any delivery mechanism can be used. However, the mechanism presented provides significant advantages in view of the user interface, simplicity of use, as well as considerations of cost efficiency and radio network utilization.

First, the user or the terminal acquires some personal content. This content is detected (step 902) by the hardware 200, and the hardware notifies (message L1) the terminal daemon 326 provided within the terminal. The terminal daemon is a terminate-and-stay-resident-type application, which wakes up when receiving a notification. The terminal daemon analyzes the notification. For example, it checks which kind of content was acquired, and then decides, partially based on the software capabilities and settings of the terminal, if an application 201 in the terminal is to be used, notification of the decision being then sent in message L3.

The terminal application 201 is loaded or activated in the terminal. If the application requires a significant computational effort, the terminal may run it with a lower priority or wait until the terminal is in an idle state in order to avoid reducing the ease of use in an annoying way. The application may extract some data from the personal content. For example, if the content in question is a digital image, it may extract some parameters, such as the time and date when the image was taken, exposure and flash settings, and so forth. It may also request some other information relating to the content, such as a positioning result. If the positioning results describing the user's past behavior are stored in a position history database, the information may be requested from there. Alternatively, the positioning result may be requested from a mobile network positioning system 282. Also, the data extraction step may include reading values from a register in the terminal, for example, the cell identifier of the current cell of the terminal, location area information, and so on.

Some other ways to perform the detection and simple data extraction steps may be implemented by implementing the system in such a way that a user indicates, for example, his/her wish to use some personalized service at a given moment by simply pressing an activation button in his/her mobile terminal. The pressing of the button may initiate the application which takes care of collecting some information, and, for example, initiate some other applications, such as a digital camera user interface. This way, when the user presses the button, if the terminal system has digital camera functionality, it may request the user to take a picture within some predefined time interval, such as 30 minutes or so, in order to utilize the content acquired with the subscribed service. Then the information relevant to the taking of the picture is extracted.

The association principles are explicitly omitted from FIG. 9, but the tasks related therein are inherently included in the process described. First of all, in step 904 the extracted data is associated with the object detected in step 902. The association may involve the linking and connecting of files and other content to each other, or storing content in the same directory or folder, for example.

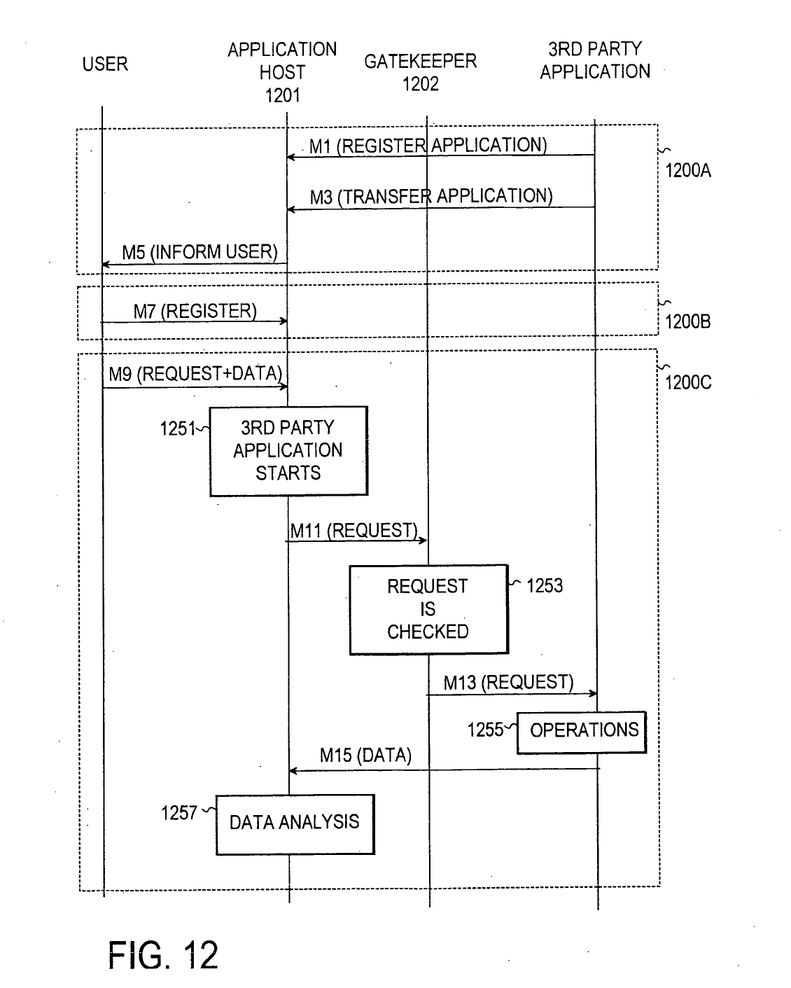

Similarly, the association is employed also in step 916, wherein the analysis step may include data associated with the object. The associated data may be delivered to server application 251 with the request. The associated data may also be filtered prior to this, as explained below with reference to FIG. 12.

When new data is generated in step 918, the association is again useful. The analysis results can be connected to the data generated as a result of the analysis, and, of course, the results may relate to the other data. The same principle of ontological structuring defined above may be employed here.

The extracted information is preferably stored (message L5) in the terminal database 202. The terminal database may be a register residing on a memory chip, such as the random access memory of the subscriber identity module, or the terminal memory, or a magnetic device such as a hard disk. Further, the terminal application may notify the upload registry 280 of the file transfer system of the operator to indicate that new content has been acquired and that the content is ready for uploading. Together with this notification there may be an indicator of the current status of the terminal device, such as the available memory, the estimated charge status of the mobile terminal battery, and so on.

In step 906 the upload registry 280 monitors the indicators sent by the mobile terminal. It may, for example, take cost efficiency or radio network usage considerations into account. This means that the uploading of the personal content is initiated when the radio network load drops below a predefined threshold, in terms of transfer price per unit of data, relative usage capacity, or available bandwidth. Also, pricing of the data transfer may be included in such a way that the transfer is preferably performed only during off-peak traffic hours. However, there may be some specific criteria which trigger immediate transfer, but these considerations are not discussed here.

When the conditions for uploading are met, the upload registry notifies a terminal daemon 322 by sending notification message L9. The terminal daemon is a separate functional unit from the terminal daemon, 326, in the sense that the terminal daemon 326 is invocable from the applications in the mobile terminal side, whereas the terminal daemon 322 accepts external notifications. This is mainly because of security considerations, because the part of the application invocable by daemon 326 has access to practically all information available in the terminal, whereas the part of application invocable by daemon 322 has access to only part of the files in terminal data storage 202.

After receiving notification L9, the daemon wakes up the terminal application 201 defined in the daemon settings. This application may be different from the application 201 referred to earlier, but it can also be implemented using modular programming techniques to restrict access to information by the corresponding parts as well. Terminal application 201 requests (message L13) data from the terminal data storage 202, for example, reads the terminal memory, and receives in message L15 the object, including personal content and data extracted from there.

After retrieving the object and data, the terminal application establishes (message L17) a connection to server daemon 402 in order to upload the object and data (message L19). The server daemon stores the uploaded content by sending it (message L21) to the MD server 240, which further stores it in the remote data repository. Then the server daemon wakes up different applications if necessary. For example, an analysis application running in application server 251 may be called by sending a wake-up call L23, and a content combination application may be invoked by sending another wake-up call L25.

The MD server 240 is the gatekeeper for the personal content. This means that it is the element where access restrictions and other confidentiality issues are considered. When requesting a service from the MD server the user can set different access policies for different parts of the data. In addition, access to a specific type of content may be restricted for some service and service application, whereas some other application may access this data. Also, policies such as read only, read only at the MD server, or similar solutions may be implemented. The purpose of the latter example is to allow third parties to supply different analysis and service applications while maintaining the privacy of the user by disallowing the misuse of confidential or strictly personal information. One preferred embodiment for the handling of confidentiality issues is discussed below with reference to FIG. 12.

The MD server 240 may inform the server daemon 402 about the subscribed services after they have been requested. This way the server daemon may send the wake-up requests L23 and L25 to the applications and it is not necessary for the MD server to perform this task.

It is obvious that there may be a plurality of applications. Here two different kinds of applications are schematically presented. The real applications are basically combinations of these two types.

Application 251 retrieves the object and stored data identified in the wake-up request L23 by posting a send command L27 to MD server 240. The MD server checks the identifier of application 251 in the message L27, compares it with an access policy table contained in the definitions 404, and returns CONTENT A according to the access policy. The request may include also a descriptor of the data desired by the application.

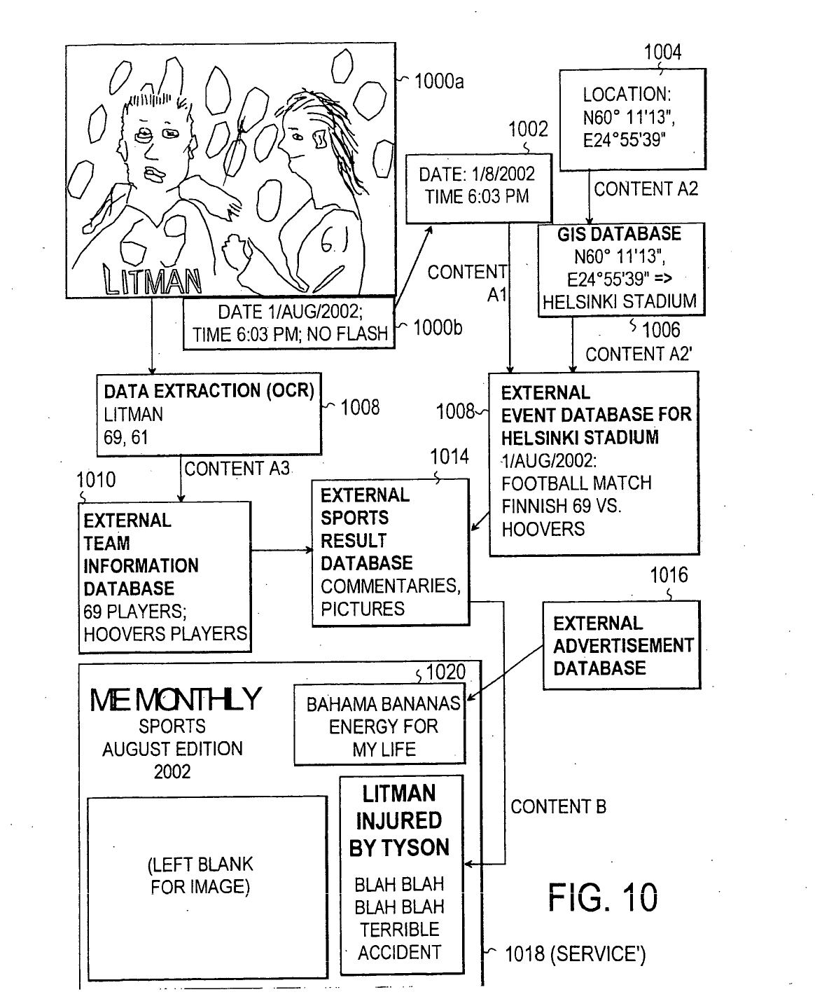

In step 916 the retrieved CONTENT A is analyzed. For example, if CONTENT A is a digital image, it may be fed to a character recognization application which attempts to identify character-like patterns in the image and to correlate them to the alphabets. CONTENT A may also be date or time information or position information. It is also possible that some further CONTENT Ai (i=2, 3, 4, . . . ) is generated on the basis of CONTENT A1. This will be explained in more detail with reference to FIG. 10. This means that in step 918 new data is generated on the basis of the first data, i.e. CONTENT A. Then the analysis application 251 stores the data by sending it to the MD server 240 as part of message L33. Further, an incremental summary L37 may be stored listing the operations which the data has gone through.

Another service application 250 performs similar tasks. It retrieves objects and data by requesting them in a message L29 from the MD server 240. Then in message L31 it fetches external data from an external database 260. It is to be noted that now the retrieved data L29 does not necessarily need to be analyzed any more because the application may have obtained the required information in the original notification L25 from the server daemon 402. As explained above with reference to FIG. 8, the external database may be practically any database accessible from the application. Basically, the retrieved external data L31 forms CONTENT B. CONTENT A is formed from parts that may have been included in the original notification L25, supplied later by the user or the MD server, or retrieved from the remote repository 242. In step 820 the data from CONTENT B and one or more data objects from different parts of the plurality forming CONTENT A may be combined or used as parameters to produce something adequate to fulfill a personalized SERVICE′. The results in the form of the generated data L35 and the incremental summary L39 are then sent for storage to the MD server.

FIG. 10 is a simplified example showing one preferred embodiment of the invention. 1000a is the digital image part of a digital image file, and 1000b is the corresponding data, i.e. the time and date of taking the picture, and some exposure parameters. The parts 1000a and 1000b together form the personal content. Typically these two parts are stored in the same file. The personal content is acquired with means located in the mobile terminal, such as a digital camera, or with means operationally connectible to the mobile terminal.

The mobile terminal hardware notifies the mobile terminal daemon that new personal content has been acquired. The daemon checks the type of the content, and because it is a digital image, wakes up a terminal application capable of extracting information from the content. The information 1000b is extracted to construct a separate item 1002, which forms CONTENT A1. Similarly, as an analysis result of the acquisition of the content, it may be deduced that a positioning result can be requested from the terminal hardware or the mobile network. This is possible because the mobile terminal is adapted to be in wireless communication with a telecommunications system. The mobile network may return positioning information 1004, which is obtained basically through the analysis of the previous event indicating that on this occasion a positioning result might be beneficial. In other words, if the user requests some service, the service may either decide that on this occasion the positioning result will be necessary or give some added value. The positioning information forms CONTENT A2, which may be further transformed by mapping in a Geographic Information System GIS database 1006, for example. The GIS database returns a clear-text value on given coordinate information. This clear-text value (which may correspond to a numeric code as well) can be regarded as CONTENT A2′, the apostrophe in this case identifying a transformation performed on the data.

Together with the timestamp information 1002 and positioning information 1004, i.e. CONTENT A1 and CONTENT A2′, mapping to an external event database can be done; it might then be possible to deduce that on the given day (CONTENT A1) in the given position (CONTENT A2′) the relevant event must have been the football match described in box 1008.

Further information about the match can be found from a separate sports database 1014. There may be results, articles, commentaries, pictures, and other similar information. This material is contained in what is termed CONTENT B.

In the selection of CONTENT B, information obtained from the acquired content may be further used. For example, if object 1000a is fed to an OCR and/or to face recognition software, but generally to any analysis software 1008, the text strings and numbers can be extracted from the given picture. The results of the extraction may form CONTENT A3. CONTENT A3 may be analyzed as in step 1010, if it is known that the information in question is information about football team members, with an external team information database. In this way, the parties playing the match can be characterized in more detail, and the sports database information best correlated with the material contained in CONTENT A1-A3 may be selected in step 1014.

The content selected in step 1014 can be used as a source for providing CONTENT B to SERVICE′ 1018. Further, the production of SERVICE′ may include selecting 1016 advertisements from a set of advertisements stored in an external advertisement database. The selected advertisements may be included 1020 in the SERVICE′ according to some predefined criteria, for example, the larger the advertisement space, the cheaper the subscription price for the user. This way the budget for the production of the services can be kept in balance if the advertisers pay on the exposure of the advertisements relative to the size and not only to the number of times the advertisements are used, the system being comparable to the advertisement pricing policy of many Internet service providers.

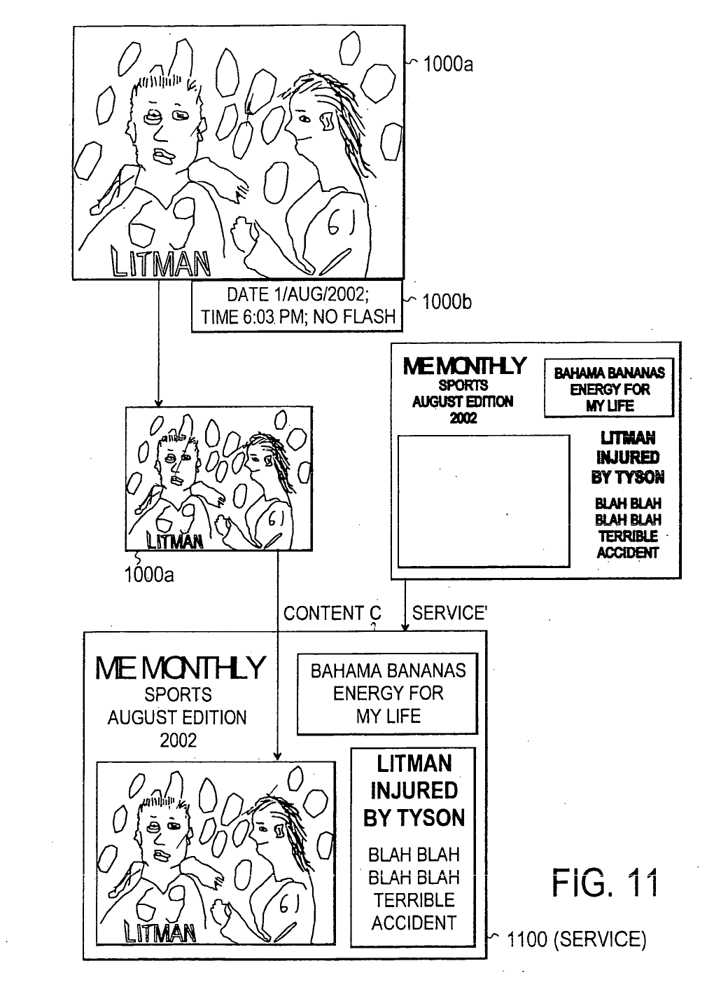

FIG. 11 illustrates how SERVICE′ may be further enriched to SERVICE 1100. The process may include analyzing the outcome of SERVICE′ and appending it with CONTENT C in an appropriate manner. In this case the original image part of the digital image file is included in SERVICE′ to produce an intangible SERVICE which then may be printed out to produce a tangible version of the SERVICE. In this way the Me Monthly magazine can be delivered to the users by regular mail, by FedEx, or by using some other convenient delivery mechanism.

FIG. 12 is an exemplary diagram showing the handling of confidentiality issues when the system has a third party application hosting the facility implemented. Preferably, the MD server has an application host 1201 and gatekeeper 1202 functionalities built in. The third party application facility is divided into three parts in FIG. 12. The messaging in dashed box 1200A shows how new services are added, the message in dashed box 1200B shows how a user may subscribe to a service, and the diagram in dashed box 1200C shows how the production of the service may be performed when the user requests a service or sends data to the MD server in order to get it analyzed.

In box 1200A, a third party wishes to offer services to MD DB users, and agrees on this with the MD DB operator by sending a registration message M1 to the application host 1201. Then the third party transfers the application in a message M3, which may consist of a source or binary code or a combination of both. Preferably the application has some set-up data, files, etc. which can all be transferred, for example, in a self-extracting compressed file such as an ARC, ZIP, or TARred file. The application host may perform some security functions, such as checking the code for possible viruses, trojans, or other susceptible features. After the application has been approved, it is stored in the application host. Then the users of the MD DB system may be notified by sending an informational message M5 which may include possible codes and addresses for using the service, as well as information on how to subscribe to the service if it is subscription-based.

In box 1200B the user registers as a new user of the added application 1201 by sending a registration message M7. This may not be necessary, because some added applications may be defined to be automatically activated for all new users. On the other hand, the subscription, or registration, can be used for administrative purposes, such as for billing and giving feedback to the third party on the number of potential users of the service. Also, the registration message M7 may comprise an indicator that tells the application host 1201 to perform some analysis task identified in the request M7 by default for all data files (i.e. personal content) supplied to the MD DB system by the user.

In box 1200C the user sends data to the application host 1201 in message M9. From the user's perspective, this may be hidden in the background and does not necessarily demand any further operations from the user, because first, as described above the data transfer may be automated, and secondly, the user may actually be sending the data to the MD server having the application host functionality available. The data may include a request for service; the request may be separate, or as already noted, the request may not be necessary if the data is handled by the third party application by default.

After the application host has received the request, in step 1251 the third party application is initiated. The initiation of the application may be performed using a daemon system corresponding to FIG. 9, or the applications may indeed be run in some processor of the application host. The request and/or user data (M9) are analyzed, on the basis of which a request M11 for information from an external database or an external application may be deemed necessary.

According to one aspect of the present invention, privacy or confidentiality issues are taken into account in the manner according to which the request M11 is handled. The MD DB system has namely a gatekeeper functionality 1202, as already referenced above. The request M11 is checked in step 1253 in order to restrict requests that might reveal user identity, user data, or some other classified or sensitive information. If the request M11 is detected as clean in the checking process 1253, it is forwarded in message M13 to a third party application. The forwarding of the message may include the setting of source and destination addresses and ports in an appropriate manner so that the return messages are directed to the corresponding application in the application hostel.

The third party application may be an internet search engine, any database implementation, or even an independent application running on an appropriate software platform. Basically the application in the application host 1201 may, for example, formulate the query string according to the data in the request M9, and the third party application where the request M13 is sent to can be the corresponding search engine. It is to be understood that in this way there are practically no limitations on what the offered service may be. Neither is it necessary that the third party application be provided by the same third party that provided the application host with the application.

In step 1255 the third party application performs operations based on the request M13. For example, in the case of the applications shown in FIG. 10 and 11, this may generate CONTENT B or CONTENT A3, or one or more of the steps 1006, 1008, and 1014. The data generated, retrieved, or acquired in step 1255 is then sent to the application host in a message M15. As in the previous example, this data may be further analyzed in step 1257, when providing SERVICE′ 1018 or a digital publication like SERVICE 1100.

However, it is to be noted that gatekeeper 1202 functions are not necessarily performed on all applications. In the previous example, if the digital version of the publication SERVICE 1100 is to be provided to the user as a printed magazine, the digital publication may be delivered to a printing house in Adobe PDF or PostScript format. In this case the MD DB system operator takes the responsibility for authorizing the third party performing the printing operation to obtain this possibly confidential information and hence is liable in regards to possible consequences if the recipient abuses this privileged information.

The services can be integrated into the system in many ways. Generally, a service belonging to the service framework can be any content provision module, such as a service application or a database. Service applications can be utilized either by using a service programming interface with any compatible programming language or by using any service user interface described by a generalized description language. Different kinds of adapters can be implemented for service integration.

Although the invention was described above with reference to the examples shown in the appended drawings, it is obvious that the invention is not limited to these, but that it may be modified by those skilled in the art without departing from the scope and spirit of the invention.

1. A system for providing personalized services for mobile users, the system comprising
a plurality of mobile terminals, each mobile terminal being provided with means for acquiring personal content and adapted to be in wireless communication with a telecommunications system,
storage means in the mobile terminal, the storage means being adapted to store at least a first part of the personal content acquired,
at least one remote data repository connected to the telecommunications system for storing at least a second part of the personal content acquired by the plurality of mobile terminals, whereby at least one of the repositories is assigned for the use of each mobile terminal,
means adapted to transfer a selected part of the personal content between the storage means and the at least one remote data repository through said telecommunications system, the means including predetermined criteria the fulfillment of which initiates said transfer,
means for extracting data from said at least a first part of the personal content,
association means for associating said extracted data with said at least a second part of the personal content, and
service provision means responsive to said association means, the service provision means being adapted to generate and/or provide a personalized service using said extracted data associated with said at least a second part of the personal content.

2. A system according to claim 1, the system further comprising
selection means for selecting data to be retrieved from an external data storage, the selection being made at least partially on the basis of said extracted data,
means for receiving said selected data, and
association means adapted to associate said received data with the personal content stored in the data repository,
wherein the service provision means are adapted to utilize said received data for generating and/or providing said personal service.

3. A system according to claim 1, the system further comprising
communication means adapted to retrieve at least one stored object and/or item of data extracted from the remote data repository and
a server including application software adapted to perform an action as a result of which information is generated, the action to utilize the retrieved object and/or said data extracted.

4. A system according to claim 1, the system further comprising means for storing said extracted information in said remote data repository.

5. A system according to claim 1, the system further comprising means for generating charging information on the basis of the action performed.

6. A system according to claim 3, the system further comprising
means to subscribe to a service by sending a request to a server,
means to process said request on said server, and
means responsive to said processing adapted to allow access of the application software to an object and/or stored information in the remote data repository.

7. A system according to claim 3, the system further comprising
means to subscribe to a service by sending a request to a server,
means to process said request, and
means responsive to said processing adapted to send an object and/or extracted information in the remote data repository to the server in order to enable provision of the service requested.

8. A system according to claim 6, wherein the service requested is identified in the request.

9. A system according to claim 6, wherein an object and/or extracted information is identified in the request, the object and/or extracted information defining the action to be performed by the server.

10. A system according to claim 2, wherein
said service includes a personal magazine in a paper and/or digital format and said received data comprising at least one item of the following data: i) calendar information, ii) image/video information, or iii) location information of the user and
said selected data received from the external data storage includes information to be laid out in a personal magazine.

11. A system according to claim 10, wherein the selection means are adapted to use at least date information extracted from said personal content in order to select objects and/or extracted data from the time interval to be laid out in the personal magazine.

12. A system according to claim 4, wherein said means for extracting data from said personal content include at least means to perform i) optical character/text recognition or ii) pattern recognition.

13. A method for providing personalized services for mobile users, the method comprising the steps of:
acquiring personal content in a mobile terminal,
storing at least a first part of said personal content in the mobile terminal,
transferring through a telecommunications system selected at least a second part of the personal content between the mobile terminal and at least one remote data repository, the transfer being initiated when predetermined criteria are fulfilled,
storing the transferred personal content in the at least one remote data repository,
assigning at least one of said remote data repositories for the use of the mobile terminal, and providing the at least one remote data repository with means for accessing the personal content stored in the mobile terminal,
extracting data from said at least a first part of the personal content,
associating said extracted data with said at least a second part of the personal content,
in response to said associating step, generating a personalized service using said extracted data associated with said at least a second part of the personal content, and
providing the personalized service to the user.

14. A method according to claim 13, the method further comprising the step of:
selecting data to be retrieved from an external data storage, the selection to be made at least partially on the basis of said extracted data,
receiving said selected data,
associating said received data with the personal content stored in the data repository, and
providing a service, the service to utilize said received data.

15. A method according to claim 13, the method further comprising the steps of:
retrieving at least one stored object and/or item of data extracted from the remote data repository and
performing an action as a result of which information is generated, the action to utilize the retrieved object and/or said data extracted.

16. A method according to claim 13, the method further comprising the step of storing said extracted information in said remote data repository.

17. A method according to claim 13, the method further comprising the step of generating charging information on the basis of the action performed.

18. A method according to claim 15, the method further comprising the steps of:
subscribing to a service by sending a request to a server,
processing said request, and
in response to said processing, allowing access of the application software to an object and/or stored information in the remote data repository.

19. A method according to claim 15, the method further comprising the steps of:
subscribing to a service by sending a request to a server,
processing said request, and
in response to said processing, sending an object and/or extracted information to the service to provide the service requested.

20. A method according to claim 18, wherein the service requested is identified in the request.

21. A method according to claim 18, wherein an object and/or extracted information is identified in the request, the object and/or extracted information defining the action to be performed by the server.

22. A method according to claim 14, wherein
said service includes a personal magazine in paper and/or digital format, said received data to comprise at least one item of the following data: i) calendar information, ii) image/video information, or iii) location information of the user and
said selected data retrieved from an external data storage includes information to be laid out in the personal magazine.

23. A method according to claim 22, wherein in the selection step at least date information extracted from said personal content is used in selecting objects and/or extracted data from the time interval to be laid out in the personal magazine.

24. A method according to claim 16, wherein said extracting of data from said personal content includes at least performing i) optical character/text recognition or ii) pattern recognition.
